(19) United States
(12) Patent Application Publication
(10) Pub. No.: US 2010/0068981 A1
(43) Pub. Date: Mar. 18, 2010

(54) Foam Buffing Pad with Compressed Foam Face

(75) Inventor: Scott S. McLain, Mukwonago, WI (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Lake Country Manufacturing, Inc., Hartland, WI (US)

(21) Appl. No.: 12/210,784

(22) Filed: Sep. 15, 2008

(51) Int. Cl. B24D 11/00; B23P 11/00; B23P 17/04

(52) U.S. Cl. 451/526; 29/428; 29/592

(57) ABSTRACT

A polymeric foam buffing pad is made from a foam preform that has a convex outer working surface slit and compressed. Preferably, the working face is slit to form a pattern of foam fingers. The slit convex preform is flattened to place the outer working surface in compression and the flattened pad is attached, in use, to a flat backing surface to maintain the compressed surface state. The invention can also be applied to an unslit preform.

### BACKGROUND OF THE INVENTION

The present invention pertains to polymeric foam pads used to buff, polish or finish painted or clear coat or other solid surfaces. In particular, the invention pertains to a unique method of making and resulting buffing pad made from polyurethane foam in which, in the preferred embodiment, the working face of the pad is slit or slotted and compressed.

As a result of the compression of the slit working face, more working foam material is forced into a given area. This has been found to substantially enhance performance of a pad made from the compressed foam and also results in a longer pad life. This is important because the preferred open cell polyurethane foam is relatively expensive. The wavy shape imparted to the compressed working face also changes the directional forces applied to the surface being finished. This, in turn, changes the angle of attack to the surface being finished, the angle being selectively variable by choice of the slitting pattern in the working face and the curvature of the foam preform from which the pads are cut.

### SUMMARY OF THE INVENTION

In accordance with the present invention, a buffing, polishing and finishing pad is made from a body of polyurethane foam that has a working face characterized by a pattern of slits in the working face which, when compressed, reduces substantially the cell structure and increases the density of the foam body in the area of the working face. The slits in the working face of the pad are preferably bidirectional and extend only partially through the thickness of the pad to form a pattern of short foam fingers. As a result of the manner in which the front face is compressed, the opposite rear face of the pad, which is unslit, is placed in tension. The bidirectional slits typically comprise two sets of parallel and mutually perpendicular slits. Alternately, the sets of slits may intersect at acute angles or the slit lines may be curved or non-linear. Unidirectional slits may also be used.

In accordance with a presently preferred embodiment of the invention, a large piece of polymeric foam material is cut to form a plurality of C-shaped foam bodies, each having a concave inner surface and a convex outer surface; the curved body is cut to form one or more pads having a working face on the outer surface; the working face of the pad is slit less than the distance to the inner surface with a pattern of multiple slits; and, the body is then flattened to cause the working face to be compressed.

Preferably, the method also includes the step of attaching the inner surface of the pad to a backing member in a substantially flattened state with the working face substantially compressed. The slitting step preferably comprises providing two sets of intersecting slits.

An alternate method comprises the steps of (1) forming a curved body from a polymeric foam material, such as open cell polyurethane foam, the body having a concave inner surface and a convex outer surface, (2) slitting the outer surface of the body less than the distance to the inner surface to form a selected pattern of slits, (3) flattening the body to cause the outer surfaces to be compressed, (4) cutting the flattened body to form a pad, and (5) attaching the inner surface of the pad to a backing member to hold the pad in the substantially flattened state and maintaining the outer surface substantially compressed. The slit pattern preferably comprises two sets of intersecting bidirectional slits that form foam fingers.

In the presently preferred method, a plurality of curved preform bodies used in making the buffing pad are made by a method including the steps of (1) providing a large bun of polyurethane foam, (2) cutting the bun on multiple spaced curved lines of generally the same shape to form a plurality of back-to-back C-shaped bodies. The curved bodies provide the preforms for the preferred pad making method.

In accordance with another method of making a buffing pad, the method includes the steps of (1) forming a hollow cylinder of polymeric foam, such as polyurethane, such that the cylinder has a cylindrical outer surface and an open core defining a cylindrical inner surface, (2) slitting the outer surface of the cylinder less than the distance to the inner surface in a pattern of bidirectional slits that define foam fingers, (3) cutting the cylinder in an axial direction along its full length to define a cylindrical piece having axially extending end faces and opposite circular edge faces, (4) opening and flattening the cylindrical piece to cause the foam fingers to be compressed, (5) cutting the flattened piece to a desired pad shape, and (6) attaching the inner surface of the pad to a backing member to hold the pad in a substantially flattened state. Preferably, the slitting step comprises forming two sets of parallel and mutually perpendicular slits. The mutually perpendicular slit sets may be positioned to be perpendicular, respectively, to the end faces and the edge faces.

In a simplified embodiment of the invention, the foam pad disk may be attached directly to the backing plate without slitting the working face. In this construction, the working face is still compressed. However, loss of the unique action provided by the slit face makes this embodiment considerably less attractive.

### BRIEF DESCRIPTION OF THE DRAWINGS

FIG. 1 is an end view of a large monolithic piece (bun) of polymeric foam showing the pattern of cuts used to form the C-shaped preform bodies from which the pads are cut.

FIG. 2 is a perspective view of one preform body cut from the foam piece of FIG. 1.

FIG. 3 shows the foam preform of FIG. 2 flattened and cut to form a plurality of buffing pads.

FIG. 4 is one of the circular pads cut from the flattened preform of FIG. 3.

FIG. 5 is a perspective view of a pad shown in FIG. 4 after the outer surface has been slit with a pattern of bi-directional slits parallel to the preform edges.

FIG. 6A is a top plan view of a pad formed with a preferred pattern of slits in the working face.

FIG. 6B is a top plan view of a pad formed with a pattern of diagonal bi-directional slits.

FIG. 7 is a side elevation view of a buffing pad of the present invention prior to attachment to a backing plate.

FIG. 8 is a bottom plan view of the pad shown in FIG. 7.

FIG. 9 is a side elevation view showing the pad attached to the backing plate.

FIG. 10 is a perspective view of a pad preform made in accordance with an alternate embodiment of the invention.

FIG. 11 is a perspective view showing the cut-out center portion to form the preform.

FIG. 12 is a top plan view showing the circular pad die cut from the flattened preform of FIG. 10.

### DETAILED DESCRIPTION OF THE PREFERRED EMBODIMENTS

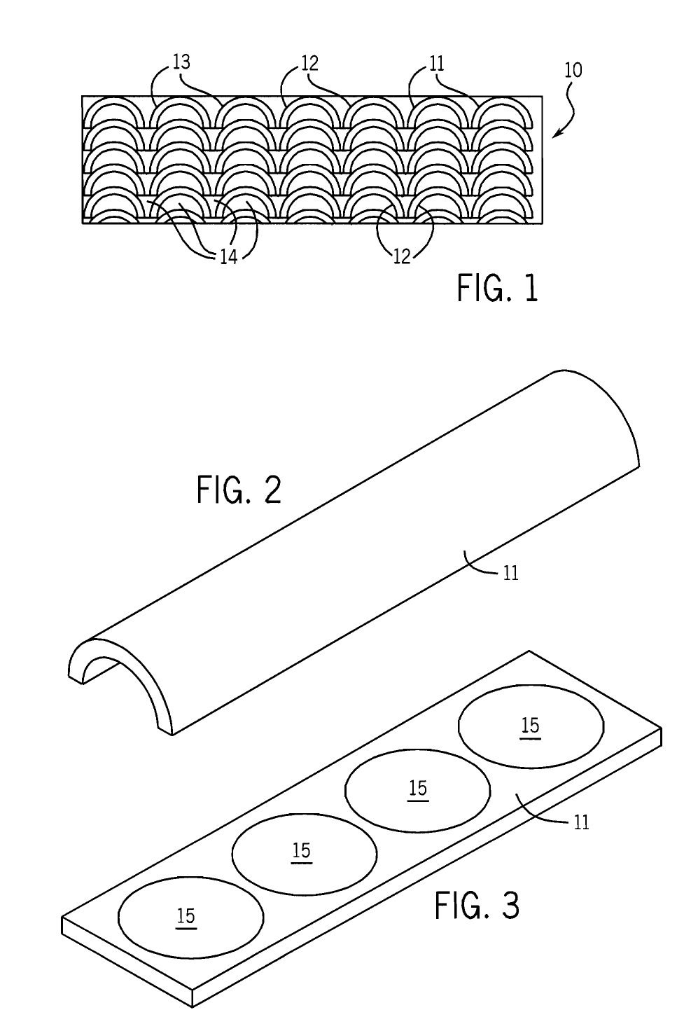

In FIG. 1, a foam slab or bun 10 is of polyurethane foam is formed in a conventional foaming process. The foam bun 10 is cut, by water jet, laser, knife or other suitable cutting tool, to form a plurality of C-shaped foam bodies 11, which are of the same shape and size. The C-shaped bodies 11 are typically 1 to 1½ inches (25-38 mm) thick, but the thickness could be varied as desired. The radius of curvature of the cut lines 12 can also vary considerably, but may, for example, be in the range of about 5 to 10 inches (127-254 mm). Further, although the cut lines 12 are preferably circular, an elliptical, oval or other cut line shape may be used. The foam bodies 11, however, must be curved as shown to provide the necessary preform for the pad forming method and resulting pad. In the indicated cut line pattern on the foam bun 10, there are waste foam trimmings 14, resulting in full semi-cylindrical bodies 11.

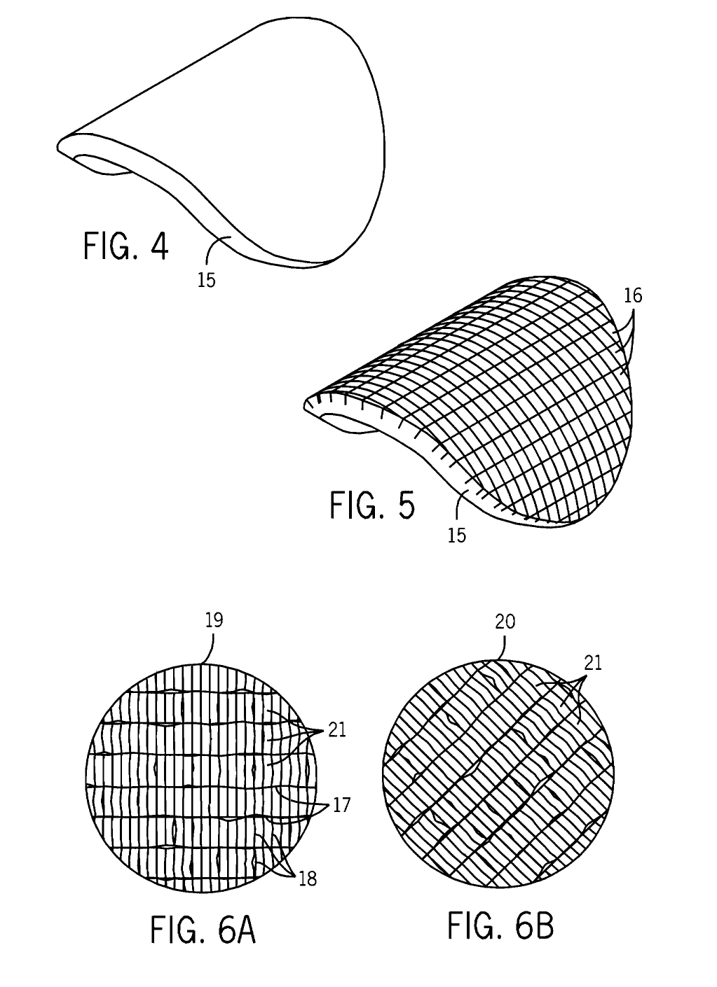

Although the foam preforms 11 are substantially semi-cylindrical in shape, they could also be cut to be shorter in the circumferential direction and/or flatter. Although this would increase the yield (and reduce the waste trimmings), full semi-cylindrical preforms 11 are presently preferred. In FIG. 2, there is shown a free standing preform 11. Referring also to FIGS. 3 and 4, the preform is die cut to form one or more foam pad disks 15. The number of disks 15 that can be cut from a foam preform 11, of course, depends on its length in a direction perpendicular to the plane of FIG. 1. After die cutting, the pad disks 15, when unconfined, resume a curved or arched shape, as shown in FIG. 4 as a result of the memory or spring back tending to return the shape to that of the preform 11.

Each foam pad disk 15 is then slit on its outer (convex) surface, which surface becomes the working face of the pad. In the embodiment shown, the slit lines comprise two bi-directional patterns of parallel slits which preferably extend in the direction of the axis of the semi-cylindrical preform 11 and perpendicular thereto. The slits 16 extend only partially through the disk 15, for example, about one-half the thickness of the disk. However, shallower and deeper slits may also be utilized and one pattern of parallel slits may be formed to a different depth than the other pattern perpendicular thereto. In FIG. 6A, there is shown a die cut and flattened foam pad disk 15 in which one set of slits 17 is more widely spaced than the other set of slits 18. This pattern has been found to perform well as a buffing pad as will be described in more detail below. In FIG. 6B, similar patterns of slits are shown in a die cut and slit disk that are formed diagonally with respect to the rectangular preform body from which the disk 20 is cut. It should be noted that in both of the flattened disks 19 and 20 of FIGS. 6A and 6B, respectively, the slits 17 and 18 result in a pattern of foam fingers 21 in the working face of the pad. Further, the fingers 21 are compressed when the pads are flattened from their curved preformed state for operation as a buffing, polishing or finishing pad.

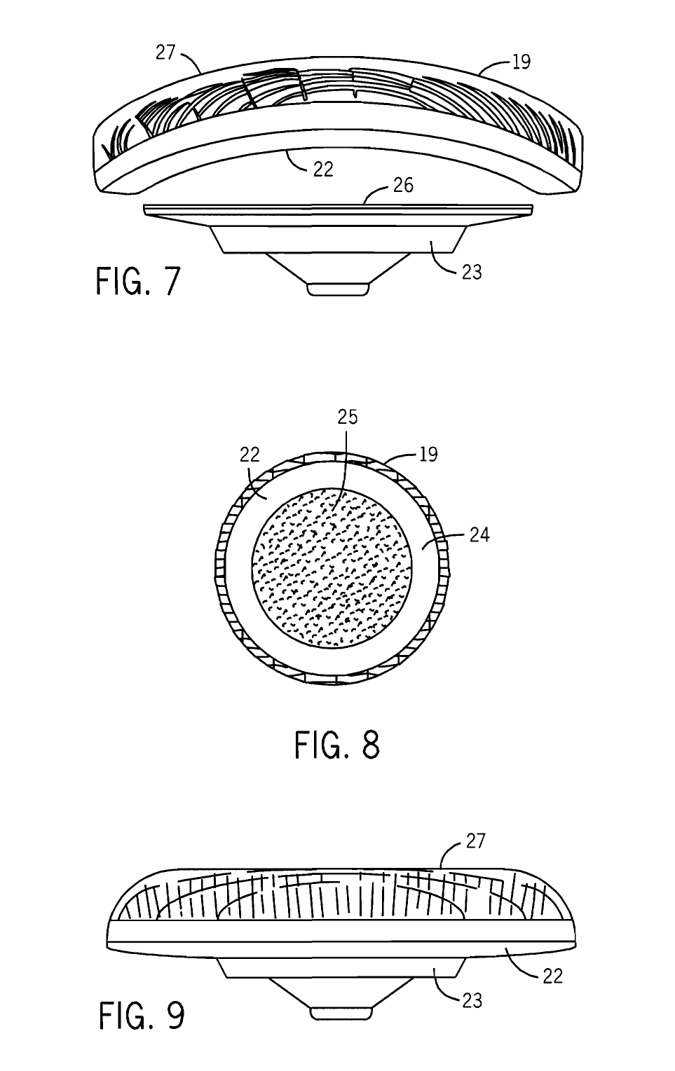

In FIG. 7, there is shown in side elevation a slit disk (FIG. 5, FIG. 6A or FIG. 6B) in which a laminated structure has been attached to the rear mounting face 22 to permit the pad to be attached to a backing plate 23. Referring also to FIG. 8, the laminated mounting face 22 of the pad 6A or 6B includes a polyethylene layer that provides a mounting medium between the mounting face of the pad and the loop half 25 of a hook and loop fastening system. The laminated polyethylene and loop half layer is heat sealed to the mounting face of the pad in a flattened state and, when the pad is relaxed, the pad assumes a semi-arched shape, but one that is significantly less curved than the free form of FIG. 5. The backing plate 23 carries the hook half 26 of the hook-and-loop fastening system. The pad is attached to the backing plate 23 which is of a rigid or semi-rigid construction, causing the pad to flatten and to again compress the pad outer working face 27. Referring again to FIGS. 6A and 6B, the working face 27 in these examples comprise short fingers 21 formed by the slitting step, previously described, and the compression causes the fingers, particularly at or near their outer ends, to be compressed together and distorted.

As a result of the compression of the foam fingers 21 when the slit disk 6A, 6B is flattened, more working foam material is forced into a given area. This has been found to substantially enhance performance and, in addition, results in a longer life pad. This is important because the preferred open cell polyurethane foam is among the most expensive foam material used in buffing, polishing and finishing operations. The wavy shape imparted to the compressed foam fingers 21 also changes the directional forces applied to the surface being finished. This, in turn, changes the angle of attack to the surface being finished, the angle being selectively variable by choice of slitting pattern.

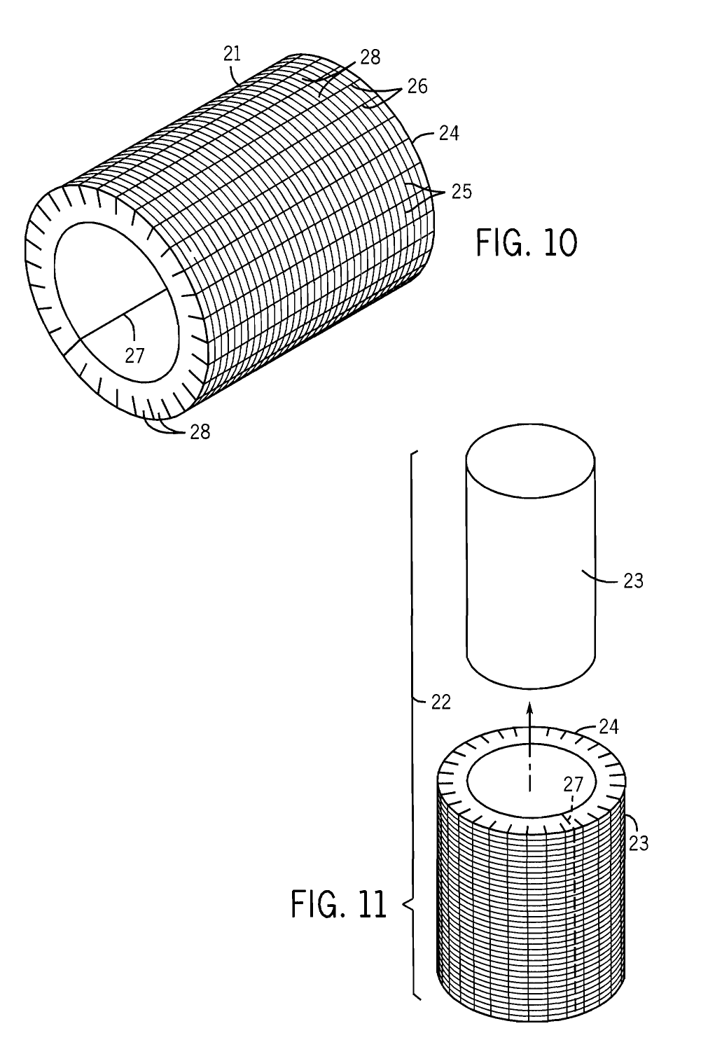

In FIG. 10, there is shown another foam preform 21 that may be used to make pads of the present invention. A monolithic foam cylinder 22 is cut to remove a central cylindrical core 23, as shown in FIG. 11. After removal of the core, a hollow foam cylinder 24 remains. The hollow cylinder 24 (or alternately the foam cylinder 22 before removal of the core 23) is provided with patterns of spaced circumferential slits 25 and spaced axial slits 26 (in a manner similar to the previously described embodiment).

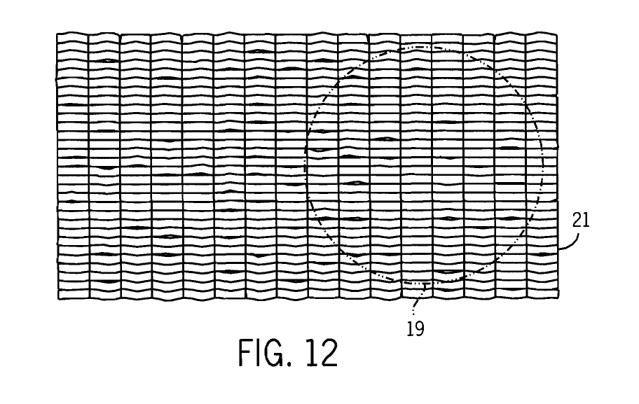

The slit hollow cylinder 24 is then cut along a separation line 27 to completely cut the hollow cylinder. The slit cylindrical preform 24 is then flattened, as shown in FIG. 12, and cut on a cut line 18 just as the previously described embodiment to form a circular pad 17. This method is not as attractive as the first method described above because of potential waste of the unused core cylinder 23. However, the resulting buffing pad 17 is virtually the same in both methods.

Many variations in slit line position and spacing may be utilized to provide many variations in the resulting performance of the buffing pad. Indeed, a unidirectional pattern of slits, one or the other of slits 25 and 26, may be used and provide the benefits described, but at a somewhat reduced scale. Although the compression of the foam fingers 28 as a result of flattening the preform is generally unidirectional, the unidirectional compression is most apparent when the slit lines are circumferential as at 25 and axial as at 26. The longer circumferential dimension of the fingers 16 in the preferred embodiment also results in more lateral distortion of the fingers when compressed. As mentioned previously, variations in compression and resultant distortion of the fingers 28 beneficially enhance the finishing capabilities of the pad.

In a simplified but less desirable embodiment of the invention, the foam pad disk 15 of FIG. 4 may be attached directly to the backing plate, as shown in FIGS. 7 and 9, without slitting the working face. In this construction, the working face is still compressed and the attachment face correspondingly placed in tension. However, loss of the unique action provided by the slit face (FIG. 5) makes this embodiment considerably less attractive.

I claim:

1. A buffing, polishing and finishing pad comprising a body of a polymeric foam material having a generally flat working face that is characterized by a pattern of slits in the working face, the slit face being compressed in the direction of the plane of the face.

2. The pad as set forth in claim 2 wherein the compression of the face is substantially unidirectional.

3. The pad as set forth in claim 1, wherein the body has a generally flat attachment face opposite the working face, said attachment face being unslit and in tension.

4. The pad as set forth in claim 1 wherein the pattern of slits comprises bidirectional slits.

5. The pad as set forth in claim 4 where the pattern of slits defines foam fingers.

6. The pad as set forth in claim 4 wherein the bidirectional slits comprise two sets of parallel and mutually perpendicular slits.

7. The pad as set forth in claim 1 wherein the polymeric foam material comprises open cell polyurethane.

8. The pad as set forth in claim 1 wherein the pad body is circular in shape.

9. A buffing, polishing and finishing pad comprising a body of a polymeric foam material having a working face that is characterized by foam fingers defined by a pattern of bidirectional slits in the working face, said fingers being compressed substantially unidirectionally.

10. The pad as set forth in claim 1, wherein the body has a generally flat unslit attachment face opposite the working face, said attachment face being in tension.

11. A method of making a buffing pad comprising the steps of:
(1) forming a curved body of a polymeric foam material having a concave inner surface and a convex outer surface;
(2) cutting the body to form a pad having a working face on the outer surface;
(3) slitting the working face of the pad less than the distance to the inner surface with a pattern of multiple slits; and,
(4) flattening the body to cause the working face to be compressed.

12 The method as set forth in claim 10 including the step of attaching the inner surface of the pad to a backing member in a substantially flattened state with the working face substantially compressed.

13. The method as set forth in claim 10 wherein the slitting step comprises providing two sets of intersecting slits.

14. A method of making a buffing pad comprising the steps of:
(1) forming a hollow cylinder of a polymeric foam material, the foam cylinder having a cylindrical outer surface and an open core defining a cylindrical inner surface;
(2) slitting the outer surface of the cylinder less than the radial distance to the open core in a pattern of bidirectional slits to define a pattern of foam fingers;
(3) cutting the cylinder in an axial direction along its full length and from the outer surface to the inner surface to define a cylindrical pieces having opposed axially extending end faces and opposite circular edge faces;
(4) opening and flattening the cylindrical piece to cause the foam fingers to be compressed;
(5) cutting the flattened piece to a desired pad shape; and,
(6) attaching the inner surface of the pad to a backing member in a substantially flattened state with the fingers substantially compressed.

15. The method as set forth in claim 14 wherein the cutting step is performed before the slitting step.

16. The method as set forth in claim 14 wherein the bidirectional slits are made to extend axially and circumferentially.

17. A method for making a buffing pad preform comprising the steps of:
(1) providing a large bun of polymeric foam, and
(2) cutting the bun on multiple spaced curved lines of generally the same shape to form a plurality of back-to-back C-shaped preform bodies.

18. The method as set forth in claim 17 including the step of slitting the outer surface of the body with a pattern of slits that define a plurality of foam fingers.

19. The method as set forth in claim 17 including the step of cutting the preform body to form a desired pad shape.

20. The method as set forth in claim 19 wherein the pads are circular in shape.

21. A buffing pad made from a preform body of polymeric foam material, the preform body having a curved shape defined by generally equally spaced convex outer and concave inner surfaces, the pad attached by the inner surface to a generally flat backing plate such that, in use, the outer surface of the foam material is compressed.

22. The buffing pad as set forth in claim 1 wherein, in use, the inner surface is in tension.
